(19) United States
(12) Patent Application Publication
(10) Pub. No.: US 2022/0285824 A1
(43) Pub. Date: Sep. 8, 2022

(54) ANTENNA ATTACHMENT FOR BOOSTING OR EXTENDING ELECTROMAGNETIC SIGNALS

(71) Applicants: Robert Antoon OBDAM, Rocky Mountain House (CA); Ellyn OBDAM, Rocky Mountain House (CA)

(72) Inventors: Robert Antoon OBDAM, Rocky Mountain House (CA); Ellyn OBDAM, Rocky Mountain House (CA)

(21) Appl. No.: 17/687,520

(22) Filed: Mar. 4, 2022

(30) Foreign Application Priority Data
Mar. 4, 2021 (CA) 3111238

(51) Int. Cl. H01Q 1/14

(52) U.S. Cl. CPC H01Q 1/14

(57) ABSTRACT

The embodiments of the invention as disclosed herein relate to a device, kit and method for boosting electromagnetic signals. Embodiments of the device, kit and method find particular utility in residential and commercial settings. Specifically, electromagnetic signals generated by various remote controls, including but not limited to, TV remote controls, garage door openers, A/C remote controls, blinds, lights, entertainment systems such as home theatres, CD and DVD players. Bluetooth connected devices and wi-fi connectivity can also be boosted by use of embodiments of the antenna attachment as described herein.

### CROSS-REFERENCE TO RELATED APPLICATIONS

This application claims priority to Canadian Patent Application No. 3,111,238, filed Mar. 4, 2021, which is hereby incorporated by reference in its entirety.

### FIELD OF THE INVENTION

The present invention relates generally to the field of antennas, specifically to and antenna attachment for boosting electromagnetic waves or signals, more specifically to an antenna attachment that boosts electromagnetic waves or signals to various transmitters such as remote controls and WiFi routers.

### BACKGROUND

Various different boosters, extenders and repeaters are known that amplify the electromagnetic signals generated from remote controls and WiFi routers.

For example, many remote controls transmit an infrared signal and its use is therefore limited to line-of-sight. An IR extender can route the IR signal from your remote control so you are still able to control your theater even though it is out of the line of sight. There are typically two general frequency ranges or bands that most household devices use. One band includes the frequencies ranging from 33-43 kHz, while the second band ranges from 44-60 kHz. Single Band IR Extenders are only compatible with one frequency are called Single Band IR extender. Typically, Single Band frequencies are only 33-43 kHz which works with most DVD and Blu Ray Players. Some extenders are dual band and work on both frequencies (33-43 kHz and 44-60 kHz), making them work with most all devices. In order to be able to control a device the remote must work on the same frequency, consequently if an IR extender is not compatible with the frequencies, it will not pass the signal or control your device.

Garage door remotes work by sending a coded signal via radio frequency (RF) to the garage door motor. Older devices utilize a single coded switch, whereas newer systems use a rolling code that changes each time the remote is used, increasing the security of the garage door by offering unique combinations. Typically, RF signals travel longer distances that IR signals, although they are particularly prone to interference from other sources. In some instances, for example when a garage has a metal roof and doors and aluminum foil insulation in the walls, the RF signal from the remote cannot activate the control box. Gate openers, automatic barrier systems, burglar alarms and industrial automation systems also utilize RF remote systems.

WiFi boosters work by capturing a signal already received from a device such as a router or hotspot and boosting or amplifying that signal to a wide area. The booster broadcasts the signal often through a larger, more powerful antenna as an additional wireless signal. Booster signals are generally stronger and more reliable than that just broadcast from your regular router. Known boosters are plugged into a power source in an optimal area of the building, the booster collects the signal from the router, then users log into the booster from their device with a password.

RC-MM is a newer IR protocol that was developed to be used with wireless keyboards and mice. The protocol uses much shorter waves than a typical IR signal and uses less power. Due to the shorter wave lengths and lower power some IR sensors are unable to process the signal. RC-MM protocol is becoming more prevalent with major brands. It is used on AT&T U-verse cable box, Cisco Explorer 4642HDC, IPN 4320, IPN 330HD and the Motorola VIP series and a growing number of products.

There is consequently a need for a universal repeater, extender or booster that amplifies any electromagnetic signal generated by various remote controls or WiFi router.

CN203325200—discloses a remote-control extension system that comprises a transmitter and a receiver which is connected with the transmitter through a coaxial cable. The transmitter receives infrared signals transmitted by an external remote controller, converts the received infrared signals into electric signals and then transmits the electric signals to the receiver; and the receiver receives the electric signals transmitted by a signal transmitting terminal, restores the received electric signals into the infrared signals and then transmits the infrared signals to corresponding source equipment through the coaxial cable.

EP3407321—discloses a system and a method for extending range of a remote control. The system comprises of at least an electronic device, a remote control, a first transceiver unit, a second transceiver unit and an infrared (IR) receiver. The IR receiver is provided in the electronic device for receiving the IR signal. The remote control transmits first IR signal to the first transceiver unit for controlling the electronic device. From the first transceiver unit a second IR signal is transmitted to the second transceiver unit. From the second transceiver unit a third IR signal is transmitted to the IR receiver thereby to extend the range of IR remote control. The second transceiver unit also detects whether the IR signal from the remote control reached the IR receiver or not and transmits accordingly the IR signal from the second transceiver unit.

U.S. RE38,208—An assembly or system for effecting control of an electronic device having an infrared sensor for receiving an infrared control signal from a manually actuated remote control comprises, in accordance with the present invention, an infrared sensor for receiving and converting the infrared control signal from the remote control to an electrical signal, the sensor being attached to an audio speaker assembly of an audio reproduction system. A signal generator also attached to the speaker assembly is operatively connected to the sensor for generating an RF carrier signal modulated by control information encoded in the infrared control signal and the electrical signal. A transmission link is provided for transmitting the modulated RF carrier signal from the speaker assembly to the electronic device. A signal receiver disposed adjacent to the infrared sensor of the electronic device receives the modulated RF carrier signal and converts the modulated RF carrier signal to a secondary infrared signal essentially identical to the infrared control signal.

U.S. Pat. No. 5,142,397—discloses a system for extending the effective operational range of an infrared remote control system. The infrared remote control system is of the type having a remote control unit with an infrared transmitter, while the controlled device includes an infrared receiver. The extender system includes a first repeater which is contained within the component compartment closely adjacent the infrared transmitter. An infrared receiver is contained within the first repeater and generates an output signal representative of the infrared signal received from the remote control unit. A radio transmitter at the first repeater then transmits a radio signal to a radio receiver at a second repeater which is physically adjacent the controlled device or devices. The radio receiver generates a second electrical signal representative of the received radio signal and this second electrical signal activates an infrared transmitter which transmits an infrared signal to the controlled device.

U.S. Pat. No. 4,509,211—A pair of transducer units and a transmission line extend the operational range of an infrared remote control device that normally operates electrical or electromechanical apparatus such as a television channel selector. The apparatus has an infrared receiver that normally cooperates with a remote control infrared transmitter. However, the transmitter has been taken to a location beyond the reception range of the receiver.

U.S. Pat. No. 5,815,108—An assembly or system for effecting control of an electronic device having an infrared sensor for receiving an infrared control signal from a manually actuated remote control comprises, in accordance with the present invention, an infrared sensor for receiving and converting the infrared control signal from the remote control to an electrical signal, the sensor being attached to an audio speaker assembly of an audio reproduction system. A signal generator also attached to the speaker assembly is operatively connected to the sensor for generating an RF carrier signal modulated by control information encoded in the infrared control signal and the electrical signal. A transmission link is provided for transmitting the modulated RF carrier signal from the speaker assembly to the electronic device. A signal receiver disposed adjacent to the infrared sensor of the electronic device receives the modulated RF carrier signal and converts the modulated RF carrier signal to a secondary infrared signal essentially identical to the infrared control signal.

CN110740368—The invention belongs to the technical field of digital television control, in particular to an infrared enhanced digital television control method, which comprises the following steps that a television box is arranged separately from a television, the signal end of the television box is connected with an infrared extension line with a terminal control chip, the terminal of the infrared extension line is fixed at a position close to the television, and the signal end in the television is provided with an infrared processing module comprising an infrared remote control signal repeater.

CN201001143—The utility model relates to a multi-region extension system which comprises a set-top box, a remote control signal transponder, and a set-top box signal converter, wherein the set-top box is used for decoding the digital part in a cable TV signal, transforming into a video and sound separation signal, and then transmitting back to the set-top box signal converter. The remote control signal transponder is used for receiving the infrared remote control signal in the sub-region, and transforming into a wireless radio-frequency signal to send into the air; the set-top box signal converter is used for receiving the wireless radio-frequency signal in the air and transforming into an infrared remote control signal, and after transformation and modulation, sending to the set-top box.

US20080165284—An antenna member includes a main body, a receiver extending from the main body configured for receiving TV signals, an infrared receiver arranged in the main body configured for receiving remote control signals sent out from a remote device.

None of the above cited documents, alone or in combination satisfy the need for a universal repeater, extender or booster that amplifies any electromagnetic signal generated by various remote controls or WiFi router.

### BRIEF SUMMARY

It is an object of the invention to provide an antenna attachment for boosting or extending electromagnetic signals.

In accordance with an aspect of the invention there is provided a kit for boosting the electromagnetic signals, said kit comprising: a length of wire, having a first end and a second end; a metal clip attached to said first end of said wire; and instructions for use.

In accordance with another aspect of the invention there is provided a method of boosting electromagnetic signals, said method comprising the steps of: attaching a metal clip to a length of wire; connecting said metal clip to a receiver unit; arranging said length of wire in a direction extending away from said receiver box.

In accordance with yet another aspect of the invention there is provided a device for boosting electromagnetic signals, said device comprising: a length of wire, having a first end and a second end; and a metal clip attached to said first end of said wire.

The advantages and features of the present invention will become better understood with reference to the following more detailed description and claims taken in conjunction with the accompanying drawings in which like elements are identified with like symbols.

To easily identify the discussion of any particular element or act, the most significant digit or digits in a reference number refer to the figure number in which that element is first introduced.

### BRIEF DESCRIPTION OF THE DRAWINGS

To easily identify the discussion of any particular element or act, the most significant digit or digits in a reference number refer to the figure number in which that element is first introduced.

FIG. 1 illustrates an aspect of the subject matter in accordance with a satellite TV embodiment of the invention.

FIG. 2 illustrates an aspect of the subject matter in accordance with a cable TV embodiment of the invention.

FIG. 3 illustrates an aspect of the subject matter in accordance with a wireless network embodiment of the invention.

FIG. 4 illustrates an aspect of equipment used in accordance with one embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The embodiments of the invention as disclosed herein relate to a device, kit and method for boosting electromagnetic signals. Embodiments of the device, kit and method find particular utility in residential and commercial settings. Specifically, electromagnetic signals generated by various remote controls, including but not limited to, TV remote controls, garage door openers, A/C remote controls, blinds, lights, entertainment systems such as home theatres, CD and DVD players, Bluetooth connected devices and wi-fi connectivity can also be boosted by use of embodiments of the antenna attachment as described herein.

Remote controls work by emitting electromagnetic waves that devices can pick up. Typically, the remote controls of TV and home entertainment systems emit infrared waves. The IR remote functions as a transmitter, using light to carry signals from the remote to the device it controls. It emits pulses of invisible infrared light that correspond to specific binary codes. These codes represent commands, such as power on, volume up, or channel down. The controlled device, i.e. the receiver, decodes the infrared pulses of light into binary code that its internal microprocessor decodes, the microprocessor executes the commands.

IR remotes use LED lights to transmit their infrared signals. This results in a few limitations of the technology. Since light is used to transmit the signal, IR remotes require line-of-sight, which means a clear open path between the transmitter and receiver. This means that IR remotes won't work through walls or around corners. They also have a limited range of about 30 feet.

An alternative electromagnetic signal that is widely used in remote controls is radio-frequency (RF) which works in a similar way to IR but instead of using infrared light, the remotes transmit binary codes to a receiver via radio waves. RF remotes have a much greater range than IR remotes. RF remotes can work at distances of 100 feet or more. This makes them useful in applications such as garage door openers and car alarms. Indeed, some modern satellite television systems also use RF remotes.

Although range is greatly improved, compared to IR remotes, interference can be an issue for RF remotes due to the large number of radio waves constantly surrounding us. For example, wireless networks and cell phones both use radio signals. To get around the issue of interference, many RF remotes only transmit at specific frequencies. They can also embed digital address codes in the radio signals to ensure that a receiver only responds to the correct radio signals.

WiFi signals are also transmitted using radio waves. Devices' wireless adapter translates data into a radio signal. The wireless router receives the signal, decodes it, and sends information to the Internet using its physical Ethernet connection. WiFi boosters, repeaters, and extenders are devices to improve WiFi coverage.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

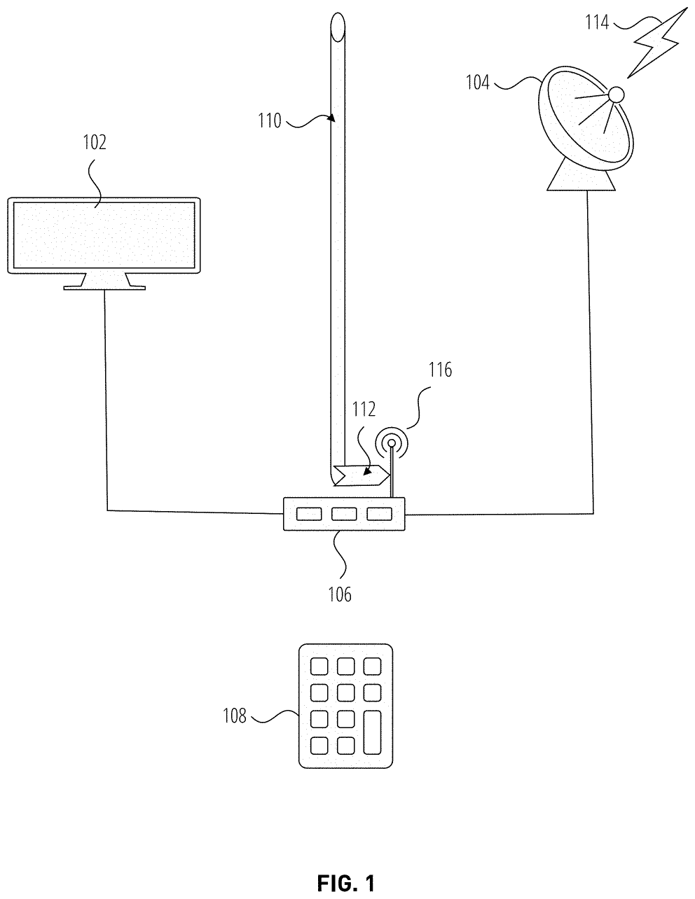

FIG. 1 illustrates a typical arrangement for a TV 102, satellite dish 104, and satellite receiver box 106. In normal operation, the satellite dish 104 receives the satellite signal 114 that is forwarded to the satellite receiver box 106, and then to the TV 102. The satellite TV remote control 108 sends a signal to the remote control antenna 116 on the satellite receiver box 106.

As previously described, the satellite TV remote control 108 emits electromagnetic waves that the satellite receiver box 106 receives via the remote control antenna 116. Typically, the remote controls for satellite TV systems emit RF or IR waves. The satellite TV remote control 108 functions as a transmitter, sending signals to the satellite receiver box 106. The signals represent commands, such as power on, volume up, or channel down. The controlled device, i.e. satellite receiver box 106, decodes the signals into a binary code that its internal microprocessor decodes, the microprocessor executes the commands.

The embodiment of the invention illustrated in FIG. 1 shows an antenna 110 attached to the remote control antennae 116 on the satellite receiver box 106 via an antenna clip 112. The combination of the antenna 110 and antenna clip 112, when attached to the remote control antenna 116, or metal casing of the satellite receiver box 106, serves to boost the signal from the satellite TV remote control 108 to the satellite receiver box 106. In this particular embodiment, the antenna 110 is composed of a length of wire, selected from but not limited to copper, coaxial cable, speaker wire. The composition and length of the wire can be selected to provide optimal performance and typically ranges from 1 to 10 feet or longer. The gauge of the wire can vary, typically within the range from 10-28 gauge.

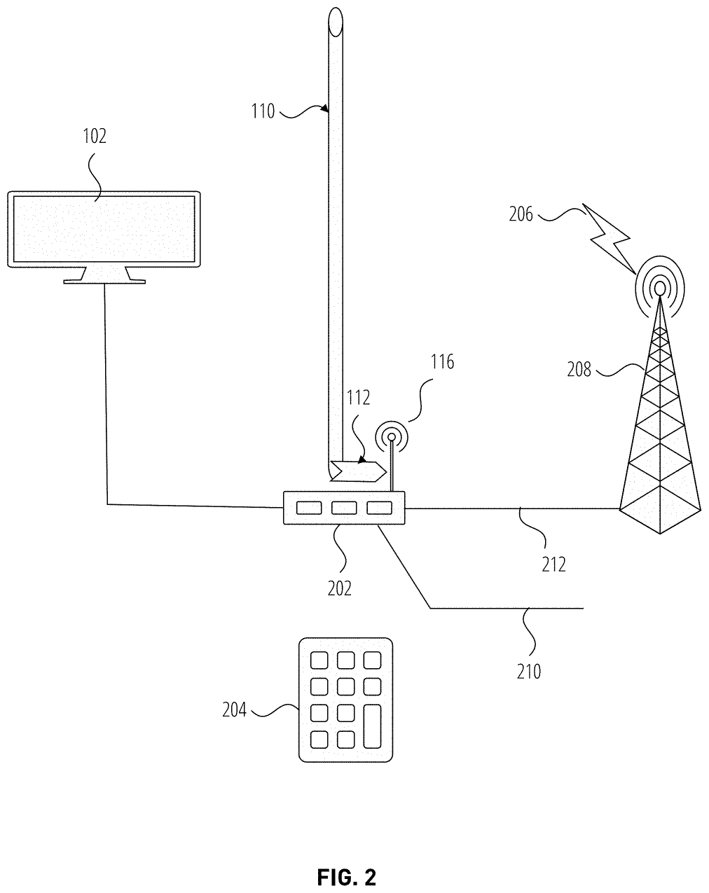

FIG. 2 illustrates a typical arrangement for a TV 102 that is receiving its cable signal via a cable TV line 212 or a fiber optic cable 210. In normal operation, the cable TV signal 206 is received via a cable TV tower 208 that is forwarded to the end user via a cable TV line 212. In the alternative, the cable signal can be delivered to the end used via a fiber optic cable 210. The cable signal then enters the cable TV receiver 202 and is forwarded to the TV 102. The cable TV remote control 204 sends a signal to the remote control antenna 116 on the cable TV receiver 202.

Similarly, as described for the satellite TV system, the cable TV remote control 204 emits electromagnetic waves that the cable TV receiver 202 receives via the remote control antenna 116. Typically, the remote controls for cable TV systems emit IR waves. The cable TV remote control 204 functions as a transmitter, sending signals to the cable TV receiver 202. The signals represent commands, such as power on, volume up, or channel down. The controlled device, i.e. cable TV receiver 202, decodes the signals into a binary code that its internal microprocessor decodes, the microprocessor executes the commands.

The embodiment of the invention illustrated in FIG. 2 shows an antenna 110 attached to the remote control antenna 116 on the cable TV receiver 202 via an antenna clip 112. The combination of the antenna 110 and antenna clip 112, when attached to the remote control antenna 116 or the metal casing of the cable TV receiver 202, serves to boost the signal from the cable TV remote control 204 to the cable TV receiver 202. In this particular embodiment, the antenna 110 is composed of a length of wire, selected from but not limited to copper, coaxial cable, and speaker wire. The composition and length of the wire can be selected to provide optimal performance and typically ranges from 1 to 10 feet or longer.

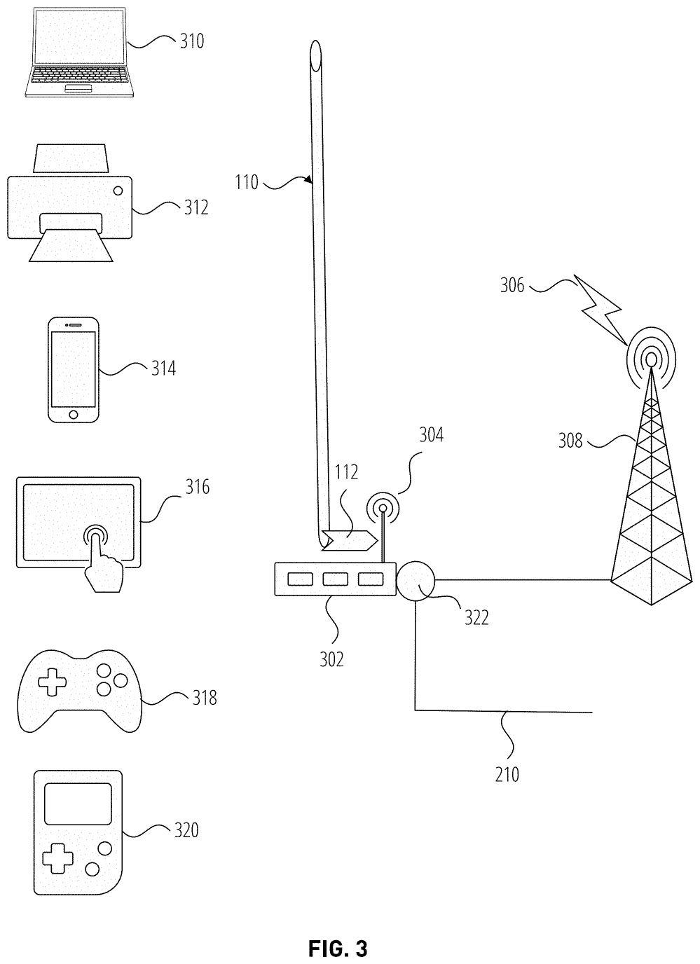

FIG. 3 illustrates a typical arrangement for a wireless router that is configured to receive information from, and transmit information to, the internet. The router then creates and communicates with the home Wi-Fi network using a built-in antenna. As a result, a variety of devices such as a computer or laptop 310, printer 312, cell phone 314, tablet 316, hand held game controls 318, and gaming devices 320, have internet access.

A wireless router is a hardware device used to connect a computer to a network without running cables from the computer to the router. A wireless router allows you to share an internet connection with several other computer users, usually within 100 feet of the wireless signal.

The wireless router when hooked up to a cable or DSL internet connection uses radio frequency waves to transmit and receive networking signals. This allows transmission of data from one location to another. Data from the devices are translated into a radio signal and then transmitted. A wireless router receives the signal, decodes it, and then sends the information to the internet using a wired connection. The router also can receive information from the internet, translate it into a radio signal, and then send it to the devices.

In normal operation, the WiFi router 302 receives internet connectivity via a cloud connection 306, WiFi tower 308 or fiber optic cable 210. As described for the satellite and cable TV system, electromagnetic waves are boosted, extended or amplified. In this embodiment the electromagnetic waves are radio waves as opposed to infrared waves.

The embodiment of the invention illustrated in FIG. 3 shows an antenna 110 attached to the w WiFi antenna 304 on the WiFi router 302. The combination of the antenna 110 and antenna clip 112, when attached to the WiFi antenna 304 or the metal casing of the WiFi router 302, serves to boost the signal from the WiFi router 302 to the devices. Similarly, when information is transmitted back to the WiFi router 302 by the devices, the combination of the antenna 110 and antenna clip 112 extends the working range of the WiFi connectivity.

In this particular embodiment, the antenna 110 is composed of a length of wire, selected from but not limited to copper wire, bare copper wire, coaxial cable, and speaker wire. The composition and length of the wire can be selected to provide optimal performance and typically ranges from 1 to 10 feet or longer.

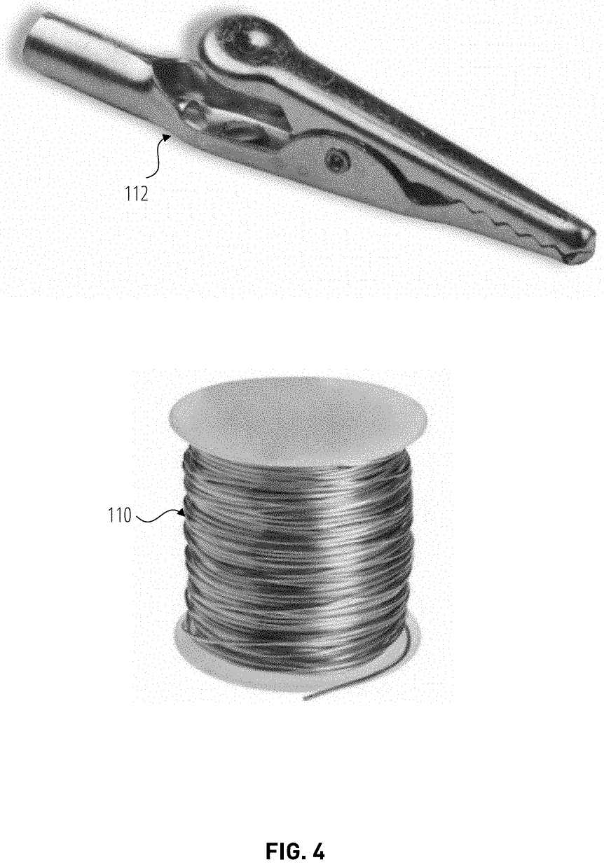

FIG. 4 illustrates, in its simplest form, the components of an embodiment of the invention. An antenna 110 can be fashioned from a length of wire. The composition and length of the wire can be selected to provide optimal performance and typically ranges from 1 to 10 feet or longer. The gauge of the wire can vary, typically within the range from 10-22 gauge. The gauge of the wire in the embodiment as illustrated is 16 gauge.

The specific composition of the wire is not critical to the functioning of embodiments of the invention. Electromagnetic waves travel through empty space or through insulating materials. The electromagnetic waves cannot travel through conducting materials such as wire, although they can travel along their surfaces. The wire may be selected from, but not limited to copper wire, bare copper wire, coaxial cable, and speaker wire, typically bare copper wire has been found to perform optimally.

Various means known to those of skill in the field may be employed to extend or shorten the length of the antenna are considered to be within the scope of protection sought by the various embodiments of the invention.

In some embodiments of the invention, the mounting mechanism shown in FIG. 4 as an antenna clip 112, may have a means of angling the antenna in a preferred direction.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A kit for boosting the electromagnetic signals, said kit comprising:
a length of wire, having a first end and a second end;
a metal clip attached to said first end of said wire; and
instructions for use.

2. The kit of claim 1, wherein said wire is selected from the group consisting of copper wire, bare copper wire, coaxial cable, and speaker wire.

3. The kit of claim 1, wherein said wire is between 10 and 22 gauge.

4. The kit of claim 1, wherein said wire is between 1 and 10 feet long.

5. The kit of claim 1, wherein said electromagnetic signals are infrared or radio frequency.

6. The kit of claim 1, wherein said infrared signals are generated by a remote-control transmitter.

7. The kit of claim 6, wherein said remote control transmitter sends signals to a satellite TV receiver, cable TV receiver, wireless router, or a garage door opener control box.

8. The kit of claim 1, wherein said metal clip is configured for attachment to a satellite TV receiver, cable TV receiver, wireless router, or a garage door opener control box.

9. A method of boosting electromagnetic signals, said method comprising the steps of:
attaching a metal clip to a length of wire;
connecting said metal clip to a receiver unit;
arranging said length of wire in a direction extending away from said receiver box.

10. The method of claim 9, wherein said metal clip is connected to an antenna on said receiver unit.

11. The method of claim 9, wherein said receiver unit is a satellite TV receiver box, cable TV receiver box, wireless router, or a garage door opener control box.

12. The method of claim 9, wherein said electromagnetic signals are infrared or radio frequency.

13. The method of claim 12, wherein said infrared signals are generated by a remote-control transmitter.

14. The method of claim 12, wherein said radio frequency signals are part of a wireless network.

15. A device for boosting electromagnetic signals, said device comprising:
a length of wire, having a first end and a second end; and
a metal clip attached to said first end of said wire.

16. The device of claim 15, wherein said wire is selected from the group consisting of copper wire, bare copper wire, coaxial cable, and speaker wire.

17. The device of claim 15, wherein said wire is between 10 and 22 gauge.

18. The device of claim 15, wherein said wire is between 1 and 10 feet long.
